(19) United States
(12) Patent Application Publication
(10) Pub. No.: US 2009/0160991 A1
(43) Pub. Date: Jun. 25, 2009

(54) UNIT PIXEL FOR USE IN CMOS IMAGE SENSOR

(75) Inventors: Hoon Kim, Seoul (KR); Kwang Sue Park, Gyeonggi-do (KR)

Correspondence Address: THE RAFFERTY PATENT LAW FIRM, 1952 Gallows Road, Suite 200, Vienna, VA, 22182-3823, US

(73) Assignee: PLANET82 INC., Seoul (KR)

(21) Appl. No.: 12/089,510

(22) PCT Filed: Apr. 12, 2006
(86) PCT No.: PCT/KR2006/001329

§ 371 Date: Oct. 10, 2008

(30) Foreign Application Priority Data
Nov. 7, 2005 (KR) 10-2005-0106192

(51) Int. Cl. H04N 5/335

(52) U.S. Cl. 348/308; 348/E05.091

(57) ABSTRACT

A unit pixel of a CMOS image sensor includes one PMOS for receiving light and generating electric signals and one NMOS that outputs the signals applied from the PMOS. Therefore, the pitch size of the pixel itself can be reduced, and the whole area by the image sensor can be also reduced. The present unit pixel improves image embodying characteristics even at low illumination, and does not require integration time, thereby enabling production of a moving picture at high speed. Further, the present unit pixel of the image sensor is formed using only a simple MOS process, which dramatically simplifies the fabrication steps. Therefore, process yield can be improved, while production cost savings can be realized. According to the present discussion, the unit pixel of a CMOS image sensor formed on a P type semiconductor substrate, includes an N type doped well, a PMOS for receiving light and generating electric signals, and an NMOS for outputting the signals from the PMOS.

### CROSS-REFERENCES TO RELATED APPLICATIONS

This is a US national stage of International Application PCT/KR2006/001329, filed Apr. 12, 2006, and further claims the benefit of priority of Republic of Korea patent application 10-2005-0106192, filed Nov. 7, 2005, subsequently registered as Republic of Korea Patent No. 10-0722690 on May 22, 2007, both applications being incorporated by reference herein in their entireties.

### INTRODUCTION

The present discussion relates to a CMOS image sensor, particularly to a unit pixel of a CMOS image sensor having a 2-transistor structure, which comprises a PMOS for receiving light and generating electric signals and an NMOS for outputting the signals received from the PMOS.

### BACKGROUND

An image sensor is a device which captures images by utilizing the characteristics of a semiconductor, which reacts to external energy such as light energy. Light generated by objects present in nature has inherent characteristic values for properties such as wavelength. A pixel of an image sensor detects the light generated from each object and converts it into a certain electric value.

As such, the pixel of an image sensor responds to the light energy generated by an object, and then generates an electrical value corresponding to the wavelength of the light received. Among this field of technology, CCD (Charge Coupled Device) refers to a device in which MOS capacitors are disposed very near to each other, and an electric charge carrier is stored in the capacitor and transferred accordingly. On the other hand, CMOS image sensors are devices which have a pixel array formed by utilizing CMOS integrated circuit fabrication, and which employ a switching mode for detecting the output of the pixel array, one after another. CMOS image sensors have the important advantage of lower power consumption, thereby being very usefully applied in personal mobile systems such as mobile telephones.

FIG. 1 represents a conventional 3-transistor CMOS active pixel, which illustrates the cross-section of a photodiode comprising circuits for peripheral components. FIG. 2 is an equivalent circuit diagram of the conventional 3-transistor CMOS active pixel represented in FIG. 1.

Referring to FIGS. 1 and 2, in conventional 3-transistor CMOS active pixels, an N+ type impurity region (11) and an N+ type floating diffusion region (13) which constitute a junction of a photodiode at one side, are in contact with each other. Thus, the capacitance component of the photodiode is substantially equivalent to the sum of the capacitor components formed by the N+type impurity region (11) and the N+ type floating diffusion region (13).

Accordingly, an image sensor where a conventional 3-transistor CMOS active pixel is applied has the problem of low sensitivity. In order to compensate for this problem of 3-transistor CMOS active pixels, 4-transistor CMOS active pixels have been suggested.

FIG. 3 represents a conventional 4-transistor CMOS active pixel, which illustrates the cross-section of a photodiode comprising circuits for peripheral components. FIG. 4 is an equivalent circuit diagram of the conventional 4-transistor CMOS active pixel represented in FIG. 3.

Referring to FIGS. 3 and 4, in conventional 4-transistor CMOS active pixels, a transfer transistor (25) which is controlled by a transfer control signal (Tx) is used for removing noise generated by a 3-transistor CMOS active pixel. The N+ type impurity region (21) and the N+ type floating diffusion region (23), which constitute the junction of a photodiode on one side, are separated from each other.

By doing so, the sensitivity of an image sensor and the quality of the sensed image produced thereby can be improved by employing conventional 4-transistor CMOS active pixels. However, the 4-transistor CMOS active pixel also has a problem of having a reduced light receiving area, owing to the addition of the transfer transistor (25).

FIG. 5 represents a circuit diagram relating to the pixel part including a combination of the unit pixels represented in FIGS. 1 and 3. The pixel part (30) refers to one column of unit pixels. The number of pixel parts (30) provided is as many as the number of columns, and the number of unit pixels provided in each pixel part (30) is as many as the number of rows.

The commonly used expressions ‘640×480 VGA’, ‘1024×768 XGA’ and ‘1280×1024 SXGA’, respectively refer to the image resolutions of ‘640 columns×480 rows,’ ‘1024 columns×768 rows’ and ‘1280 columns×1024 rows.’ Meanwhile, each number of columns and rows practically used in the processes is more than the numbers above represented. FIG. 6 represents the signals applied to the unit pixels of FIGS. 1 and 3.

The circuit and the signal processing illustrated in FIGS. 5 and 6 are as follows. When a select signal is applied to a row consisting of pluralities of unit pixels, a captured image data signal during the row enable section (R_en) in the pluralities of unit pixels is applied from the common junction (31) of a column to CDS (correlated double sampling) (36). Image data signals include data signals corresponding to various levels of illumination depending on the surrounding environment, ranging from a high illumination signal which is the data signal of bright light to a low illumination signal which is the data signal of dimmed light.

These data signals having various levels of illumination drop the reference voltage applied to a circuit comprising CDS (36) according to each level. Accordingly, the low illumination data signal drops the reference voltage relatively little, but the high illumination data signal drops the reference voltage by a relatively large amount.

FIG. 7 represents the voltage drop of a data signal according to each of three example illumination levels. Three levels are illustrated in FIG. 7, for the sake of convenience; however data signals at various other levels may be present in practice.

In FIG. 7, the ‘A’ and ‘C’ sections are stable sections where the fluctuations in signal voltage are not present, and ‘B’ section is where a drop in signal voltage occurs. First, while a row enable signal (R_en) is disabled, a reset sampling operation signal (SR) is applied to a switch b (32b) of a CDS (36) during the reset sampling section (A) so that the reset voltage is stored in a capacitor b (33b).

After that, upon application of the row enable (R₁₃ en) signal (e.g., as illustrated among the signals of FIG. 6) to each unit pixel in a row so that an image data signal is applied to a common junction (31) of a column, then the switch a (32a) of CDS (36) processes data sampling (SD) during C section by the data sampling operation signal applied from outside, stores the resulted value in a capacitor a (33a) and applies a data signal voltage to MUX (35) via a comparator a (34a).

Completing the data sampling (SD), the reset (RST) signal is applied. Then, upon the completion of row enabling, a switch b (32b) of CDS (36) for processing the next image process data processes reset sampling (SR) during section A by a reset sampling operation signal applied from outside so as to store the reset voltage to a capacitor b (33b) and to apply a signal to MUX (35) via a comparator b (34b).

Upon running of such series of signals (R_en, SD, RST, SR) for one cycle, image data stored in the unit pixel are obtained, and then the obtained image data are outputted through a sample and hold amplifier (SHA) (37), a programmable gain amplifier (PGA) (38), an analogue-digital converter (ADC) (39) or the like.

In summary, a conventional 3-transistor CMOS active pixel has the problem of low sensitivity, and also, a conventional 4-transistor CMOS active pixel has the problem of a reduced light receiving area.

### SUMMARY

Accordingly, in order to solve the above-noted problems, inter alia, a unit pixel is provided which is formed with one PMOS that receives light and generates electrical signals and one NMOS that outputs the signals applied from the PMOS, so that the pitch size of the pixel itself can be reduced. Therefore, at least one object of the present discussion is to reduce the area occupied by the unit pixel and further to significantly reduce the area occupied by the image sensor overall.

Further, since the amount of electric current flowing through the source and the drain is large, even if only a small amount of light enters into the light receiving element, the image sensor of the present discussion has excellent imaging characteristics even at lower illumination. Therefore, another object of the present approach—in which conventional integration time is not necessary—is to enable imaging of a moving picture at high speed.

The present approach can dramatically simplify processing by eliminating some processes for fabricating a conventional CMOS image sensor, such as the process for forming an epitaxial layer on the surface of the light receiving area for preventing dark current and the process for forming a micro-lens on the upper part of an image sensor for raising the fill factor of a photodiode region, thereby achieving improvements in process yield as well as cost savings.

### BRIEF DESCRIPTION OF THE DRAWINGS

FIG. 1 is a view illustrating a conventional 3-transistor CMOS active pixel.

FIG. 2 is an equivalent circuit diagram illustrating a conventional 3-transistor CMOS active pixel.

FIG. 3 is a view illustrating a conventional 4-transistor CMOS active pixel.

FIG. 4 is an equivalent circuit diagram illustrating a conventional 4-transistor CMOS active pixel.

FIG. 5 is a circuit diagram connected to the pixel part which includes a combination of the unit pixels represented in FIGS. 1 and 3.

FIG. 6 illustrates a signal applied to the unit pixels represented in FIGS. 1 and 3.

FIG. 7 represents the voltage drop of a data signal according to several illumination levels, as applied to conventional techniques.

FIG. 8 is a circuit diagram illustrating transmission of signal current in CMOS unit pixels according to an example embodiment of the present approach.

FIG. 9 is a view illustrating the cross-section of a CMOS unit pixel according to a first embodiment.

FIG. 10 is a view illustrating the changes in PMOS current in a CMOS unit pixel of an example embodiment of the present approach, depending on changes in light intensity.

FIG. 11 is a view illustrating the cross-section of a CMOS unit pixel according to a second embodiment.

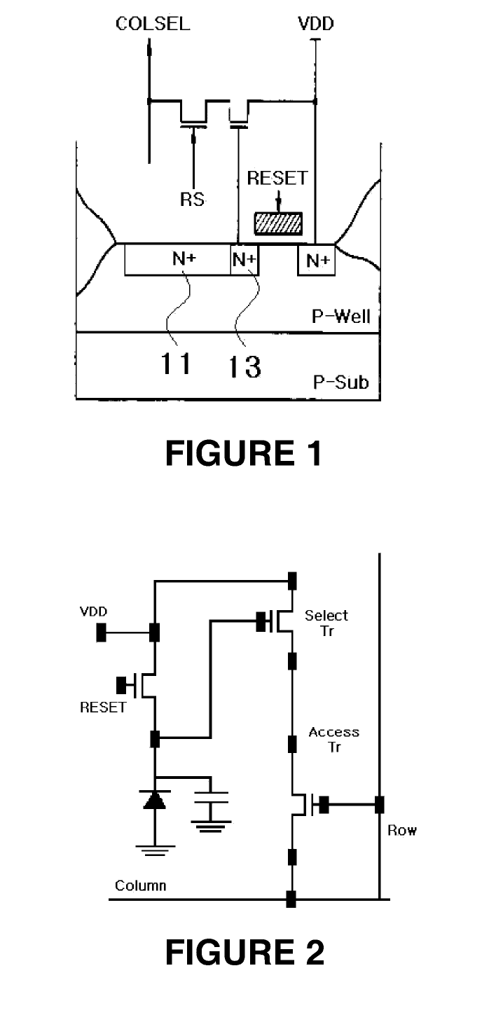

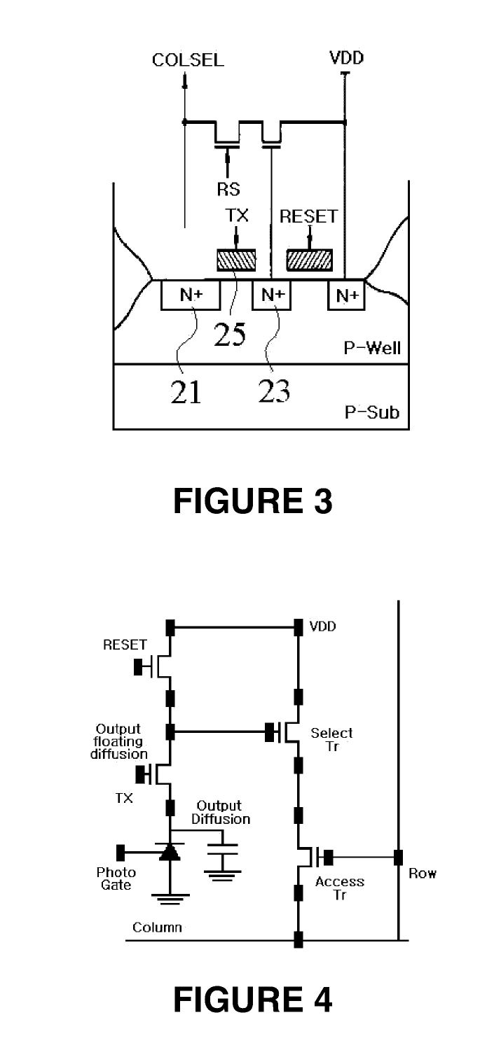

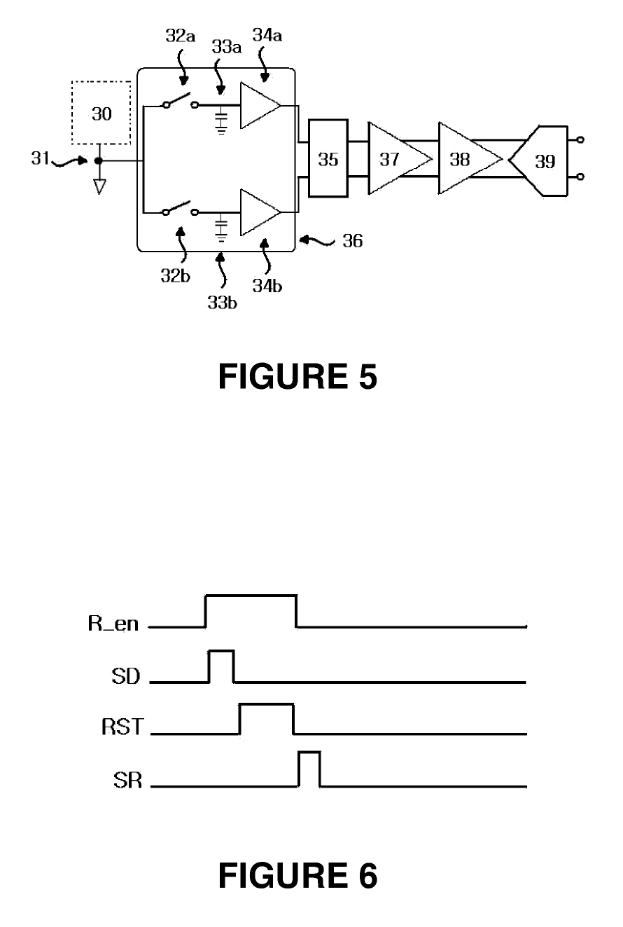

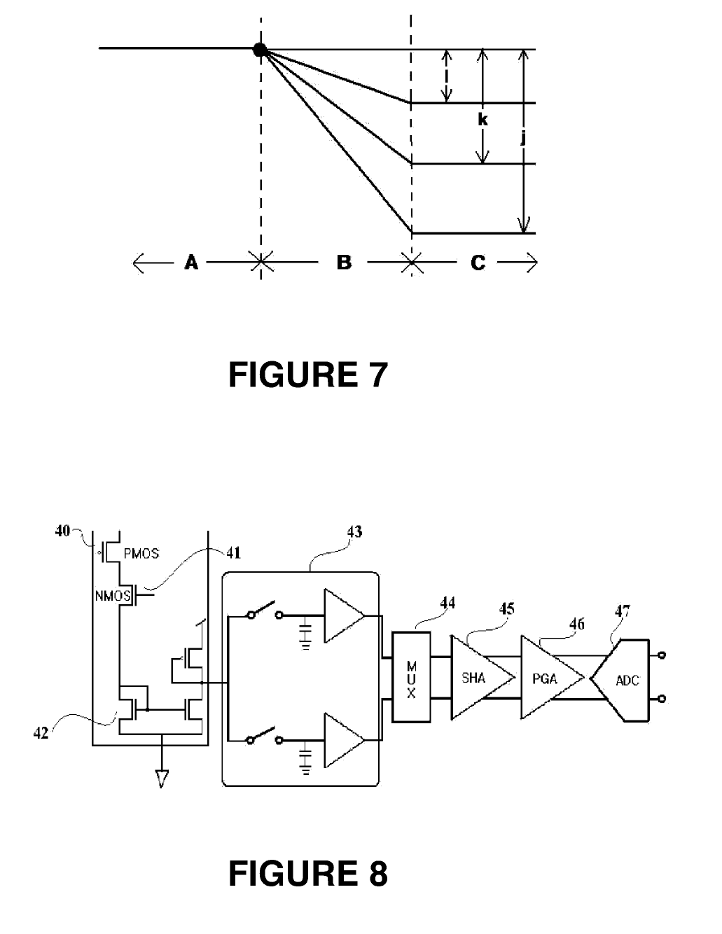

### DETAILED DESCRIPTION

The above-noted, as well as various other objects may be achieved by a unit pixel of a CMOS image sensor, which is formed on a first impurity type semiconductor substrate, and includes a second impurity type doped well, a PMOS for receiving light and generating an electric signal, and an NMOS for outputting the signals from the PMOS.

The first impurity type is P type, and the second impurity type is preferably N type.

Regarding the PMOS, a source and a drain are formed inside the well of the PMOS, and the gate of the PMOS is preferably floated.

The gate of the NMOS preferably receives a selecting signal applied from outside.

For connecting the gate of the PMOS with the well, the unit pixel may further include a connecting part formed on the well. The connecting part is doped with the same impurity type as used in the well, in which the concentration of doping is preferably higher than that of the well.

In order to connect the connecting part with the gate of the PMOS, it is preferred to form a metal contact on the upper part of the connecting part.

It is to be understood that the terms and words used in the specification and claims of the present invention should not be construed to have any limiting meaning as may be provided by conventional definitions or dictionaries, but should instead be understood to have such meaning and to convey a concept corresponding to the technical spirit of the present discussion, based on the principle that an inventor may appropriately define the concept and meaning of terms in order to explain the invention to its best.

Accordingly, it is to be understood that each of the following example embodiments and the constructions illustrated in the accompanying drawings are merely preferred examples, and are not intended to comprehensively represent every possible embodiment or variation corresponding to the present invention. Therefore, it should be further understood that various alternatives and modifications can be substituted in accordance with the present invention.

Hereinafter, example embodiments are described in detail, with reference to the accompanying drawings.

FIG. 8 is an equivalent circuit diagram representing a CMOS image sensor operation according to a first and a second embodiment.

The CMOS pixel array senses the image of an external object; divides the image of the object in correspondence with the number of unit pixels; and generates respective electrical signals each corresponding to respective light inputs having different levels of brightness. In each unit pixel, the electrical charges corresponding to the absorbed amount of light (light intensity) are selectively transferred through the N-well of the PMOS (40) and NMOS (41), where the NMOS generates an electrical current by dividing electron-hole pairs (EHP) in a depletion layer depending on the light intensity and thus generating an electrical charge carrier, as well as serving as a switch by being connected to the PMOS, in which the depletion layer is present in the P-N hetero-junction region where a P type corresponding to a source and an N type of N-well corresponding to a drain meet each other.

Therefore, a large photocurrent generated from the PMOS, which is used as a light receiving element, is transmitted to a current mirror without charge storage. The electrical current is amplified by the current mirror (42), and the amplified current is logarithmically converted to voltage. The converted voltage is read out by a circuit formed with a CDS (43), MUX (44), and SHA (45), and is then outputted as image data through a PGA (46) and ADC (47). By applying this to active pixels, it is possible to dramatically reduce the charge storage time.

### EXAMPLES

(First Embodiment)

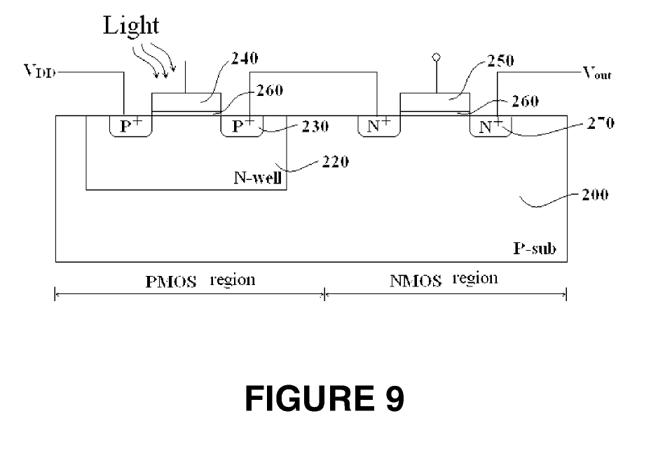

FIG. 9 is a view illustrating a CMOS image sensor according to a first embodiment. Only the MOS process—which is conventionally used in semiconductor fabrication—is used to fabricate the presently discussed unit pixel. The unit pixel structure is a 2-transistor structure including one PMOS and one NMOS, in which the PMOS, which utilizes a photoelectric conversion mode upon entrance of light, forms a light receiving area, and the NMOS plays the role of a switch by being connected to the PMOS.

By embodying a unit pixel structure having two transistors—unlike the conventional unit pixel structure having one photodiode and three transistors, or one photodiode and four transistors—the pitch size of the unit pixel can be reduced. Further, since there is no control signal such as conventional reset signals, a metal line in the layout of a pixel can be also reduced. Therefore, the unit pixel structure of the present discussion can be simplified.

A method for fabricating a unit pixel according to an example embodiment of the present discussion is as follows.

An N-well (220) is formed in a PMOS area in order to form a PMOS and an NMOS on a P type semiconductor substrate (200). The process for forming the N-well includes forming patterns on a P type semiconductor substrate, carrying out an ion implantation process of an N type impurity such that the region where the N-well is to be formed is only open, and then forming the N-well by heat treatment. The gate oxide (260) and polysilicon are sequentially deposited on the front side of the substrate where the N-well is formed. The resulting substrate is patterned, and then selectively etched so as to form a floating gate (240) on the PMOS and a select gate (250) on the NMOS, respectively.

Later, a mask which is only open at the source/drain formation region of the PMOS region is formed, and then P type ion implantation at high concentration is carried out so as to form a source/drain (230). Sequentially, a mask which is only open at the source/drain formation region of the NMOS region is formed, and then N type ion implantation at high concentration is carried out so as to form a source/drain (270). Additionally, a Salicide process may be further carried out on the region of PMOS and NMOS where each source/drain is formed in order to reduce resistance. However, since the PMOS of the present invention is a photoelement which receives light, and thus light should be permitted to penetrate through a floating gate formed on the upper part of the PMOS, the Salicide process should therefore not be performed on the floating gate.

The principle of operation of a unit pixel according to the first embodiment is explained below.

Upon the application of voltage to the source of the PMOS formed on the same substrate where the NMOS is formed, the N-well of the PMOS forms a depletion region which is in an electrically neutral state. Later, when photons enter into the N-well (which is a depletion region), upon receiving light from the PMOS light receiving part, electron hole pairs (EHP) are formed, which drives the formation of a P channel on the lower surface of the gate in the PMOS element. Voltage is applied to the select gate formed on the NMOS, which is connected to the PMOS, and then an N channel is formed between the source and drain formed on the NMOS so that it can receive the signal charges formed on the PMOS and send out an output signal.

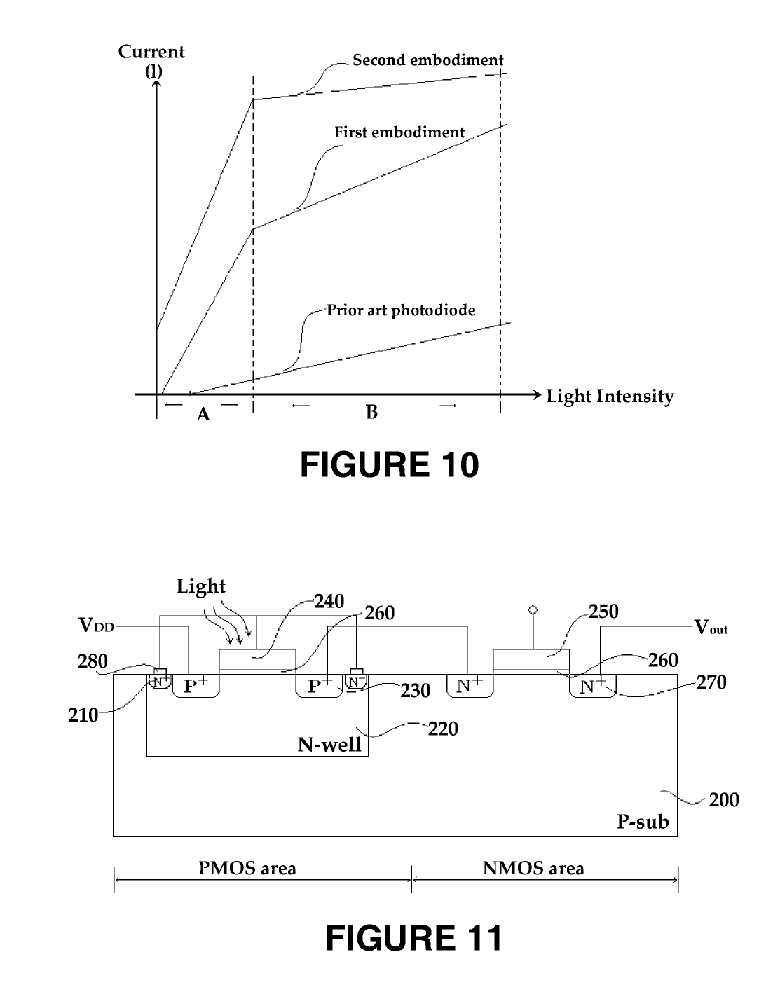

With reference to FIG. 10, in a conventional photodiode, an electrical current starts to flow when the intensity of light is over a certain critical point, and the current linearly increases with an increase in the intensity of light. However, the pixel of an image sensor including a PMOS according to the present discussion is a structure in which an electrical current starts to flow right after the entrance of light, thereby having no dark current. As represented in region A of FIG. 6, the slope of the change in electrical current relative to small changes in light is very rapid and, at the same time, the slope of the change in electrical current relative to changes in light is relatively gradual in region B.

Since the first example embodiment does not necessarily have a control signal such as a conventional reset signal, a metal line in the layout of a pixel can therefore be reduced, making it possible to further reduce pitch size as compared to that of a conventional unit pixel. In the PMOS light receiving element of the present discussion, one photon generates an amplified photocurrent, unlike in a conventional CMOS image sensor in which one photon generates one electron-hole pair. Therefore, the current gain of a corresponding photocurrent can reach up to the range of 100 to 1000, and thus it is possible to produce an image even under low illumination conditions where only a small amount of light enters. Further, the present discussion makes it possible to reduce the charge storage time by between 100 and 1000 times relative to conventional image sensors; as a result, just several tens of clocks of delay become enough for the charge storage time, unlike in conventional image sensors which require 1 frame or 1 line of delay. Therefore, it is possible to eliminate integration time and thus to achieve a high speed moving picture.

Additionally, since the unit pixel of a CMOS image sensor according to the present discussion is formed by a general MOS process, it eliminates the conventional use of an exclusive or one-off process for a CMOS image sensor. According to the present discussion, it is possible to receive light from a PMOS, with almost no integration time, and to output signals through an NMOS; therefore, a dark current in the sensor caused by lengthy integration can be minimized, aside from the dark current caused by the leakage current of an MOS for a switch. Accordingly, the present discussion does not require a process for growing an epitaxial layer on the surface of a light receiving area for preventing dark current, as in conventional CMOS image sensor fabricating processes. Further, the present discussion does not require a conventional process for forming a micro-lens on the upper part of a unit pixel for collecting light to the light receiving area of a unit pixel, since the PMOS light receiving element of the present discussion generates amplified photocurrent per each photon. By eliminating such conventional processes, the present discussion can have a cost-saving effect.

(Second Embodiment)

The second example embodiment provides a structure in which the gate of PMOS and the N-well of PMOS are connected to each other.

FIG. 11 is a view illustrating a unit pixel structure of a CMOS image sensor according to the second embodiment, in which the unit pixel is fabricated using only an MOS process, which is also used for conventional semiconductors. The unit pixel structure is a 2-transistor (2T) structure having one PMOS and one NMOS, in which the PMOS-utilizing a photoelectric conversion mode upon entrance of light-forms a light receiving area, and the NMOS plays the role of a switch by being connected to the PMOS. A unit pixel in which the gate of said PMOS and N-well are connected is formed.

Therefore, the present discussion is capable of simplifying the unit pixel structure by decreasing the pitch size of a unit pixel owing to the 2T structure of the unit pixel, which conventionally has a structure of one photodiode with three transistors, or one photodiode with four transistors, and also by reducing the metal line of a pixel layout due to the absence of a control signal such as a conventional reset signal.

The unit pixel according to the second example embodiment is described as follows.

An N-well (220) is formed in a PMOS area in order to form PMOS and NMOS on a P type semiconductor substrate (200). The process for forming the N-well may include forming patterns on a P type semiconductor substrate, carrying out an ion implantation process of an N type impurity such that the region where N-well is to be formed is only open, and then forming the N-well by heat treatment. The gate oxide (260) and polysilicon are sequentially deposited on the front side of the substrate where the N-well is formed. The resulted substrate is patterned, and then selectively etched so as to form a floating gate (240) on the PMOS and a select gate (250) on the NMOS, respectively.

Later, a mask which is only open at the source/drain formation region of the PMOS region is formed, and then P type ion implantation at high concentration is carried out so as to form a source/drain (230). Sequentially, a mask which is only open at the source/drain formation region of the NMOS region is formed, and then N type ion implantation at high concentration is carried out so as to form a source/drain (270).

A contact area (210) is formed on the surface of the N-well for connecting the gate (240) formed on the PMOS with the N-well (220). N type ions are implanted at the contact area of the N-well (210) with a concentration higher than the concentration of ions used in the N-well formation. A metal contact (280) is formed on the area implanted with a high concentration of N type ions, and then the PMOS and N-well are electrically connected.

In the second embodiment, since the PMOS is a photoelement which receives light, and thus light should be permitted to penetrate through a floating gate formed on the upper part of the PMOS, therefore the Salicide process should not be carried out on the floating gate.

The principle of operation of a unit picture element according to the second example embodiment is explained below.

Upon the application of voltage to the source of the PMOS formed on the same substrate where the NMOS is formed, the N-well of the PMOS forms a depletion region which is in an electrically neutral state. At this time, photons enter into the N-well (which is a depletion region), by receiving light from a light receiving part of the PMOS so as to form EHPs. At this stage, if voltage is applied to the gate, the electrons which remain on the N-well connected to the gate serve as a source of bias in the substrate, thereby lowering the threshold voltage (i.e., the minimum voltage required for channel formation). Therefore, a P channel is easily formed. Then, voltage is sequentially applied to the select gate formed on the NMOS which is connected to the PMOS, and an N channel is formed between the source and the drain formed on the NMOS so that the signal charge formed on the PMOS can be received and an output signal is then sent out.

With reference to FIG. 10, in a conventional photodiode, an electrical current starts to flow when the intensity of light is over a certain critical point, and the current linearly increases with an increase in the intensity of light. However, in the unit pixel according to the present second example embodiment, when voltage is applied to the gate, the electrons remaining on the N-well connected to the gate serve to generate bias in the substrate, thus lowering the threshold voltage (the minimum voltage required for channel formation). As represented in region A of FIG. 10, the slope of the change in electrical current relative to small changes in light is very rapid, compared to the changes exhibited in connection with the first example embodiment. At the same time, the slope of the changes in electrical current relative to changes in light in region B of FIG. 10 is relatively gradual, compared to the first embodiment.

Since the second embodiment, as in the first embodiment, does not have a control signal such as a conventional reset signal, a metal line in the layout of a pixel can become reduced, making it possible to reduce a pitch size as compared to that of a conventional unit picture element. According to the second embodiment, it is possible to produce a clear image even with low illumination, since a large amount of electrical current can be generated even when only a small amount of light enters the PMOS. Further, according to the second embodiment, hardly any integration time is required, making it possible to achieve a high speed moving picture.

According to the second embodiment, it is possible to eliminate a conventional process exclusively needed for a CMOS image sensor, by embodying a unit pixel through a MOS process, which is a generally used process; therefore it can be further expected that it would bring about an increase in process yield and a decrease in costs for processing.

The discussion as described so far has been illustrated by the example embodiments; however, the present invention is not limited to the foregoing examples or embodiments. Rather, various alternatives, modifications, and variations are apparent to those skilled in the art, which can be applied in connection to the present invention without departing from the spirit or scope thereof.

According to the present discussion, the unit pixel of an image sensor may be formed with one NMOS and one PMOS light receiving element, and the pitch size of the pixel itself can be reduced. Therefore, it is possible to reduce the area encompassed by a unit pixel and further to significantly reduce the whole area encompassed by the image sensor.

Further, since the amount of electrical current flowing through the source and the drain is large, even if a small amount of light enters into the light receiving element, the image sensor of the present discussion has excellent image production characteristics even at lower illumination. Additionally, in the image sensor of the present discussion, conventional integration time is not necessary, thereby facilitating generation of a high speed moving picture.

The present approach can dramatically simplify the associated processing steps by eliminating some processes for fabricating a conventional CMOS image sensor, such as forming an epitaxial layer on the surface of the light receiving area for preventing dark current and forming a micro-lens on the upper part of an image sensor for raising the fill factor of the photodiode region, thereby achieving other objects such as improvement in process yield as well as cost savings.

1. A unit pixel of a CMOS image sensor, formed on a first impurity type semiconductor substrate, and the unit pixel comprising:
a second impurity type doped well;
a PMOS configured to receive light and generate an electrical signal; and
an NMOS configured to output the electrical signal from the PMOS.

2. The unit pixel of a CMOS image sensor according to claim 1, wherein the first impurity type is P type.

3. The unit pixel of a CMOS image sensor according to claim 1, wherein the second impurity type is N type.

4. The unit pixel of a CMOS image sensor according to claim 1, wherein a source and a drain are formed inside a well of the PMOS.

5. The unit pixel of a CMOS image sensor according to claim 1, further comprising a gate of the PMOS,
wherein the gate of the PMOS is floated.

6. The unit pixel of a CMOS image sensor according to claim 1, further comprising a gate of the NMOS,
wherein the gate of the NMOS is configured to receive a select signal applied from outside.

7. The unit pixel of a CMOS image sensor according to claim 1, further comprising a connecting part configured to connect a gate of the PMOS with the well,
wherein the connecting part is formed on the well.

8. The unit pixel of a CMOS image sensor according to claim 7, wherein the connecting part and the well both include doping of a same impurity type.

9. The unit pixel of a CMOS image sensor according to claim 7, wherein a doping concentration of the connecting part is higher than that of the well.

10. The unit pixel of a CMOS image sensor according to claim 7, further comprising a metal contact disposed on an upper part of the connecting part, connecting the connecting part with the gate of the PMOS.

11. A method for forming a unit pixel of a CMOS image sensor, comprising:
forming a second impurity type doped well on a first impurity type semiconductor substrate;
forming a PMOS for receiving light and generating an electrical signal; and
forming an NMOS for outputting the electrical signal from the PMOS.

12. The method according to claim 11, wherein the first impurity type is P type, and wherein the second impurity type is N type.

13. The method according to claim 11, further comprising forming a source and a drain inside a well of the PMOS.

14. The method according to claim 11, further comprising forming a gate of the PMOS such that the gate of the PMOS is floated.

15. The method according to claim 11, further comprising forming a gate of the NMOS for receiving a select signal applied from outside.

16. The method according to claim 11, further comprising forming a connecting part on the well, for connecting a gate of the PMOS with the well.

17. The method according to claim 16, wherein the connecting part and the well both include doping of a same impurity type.

18. The method according to claim 16, wherein a doping concentration of the connecting part is higher than that of the well.

19. The method according to claim 16, further comprising forming a metal contact on an upper part of the connecting part, connecting the connecting part with the gate of the PMOS.

20. An apparatus for forming a unit pixel of a CMOS image sensor, comprising means for performing the method of claim 11.
